(19) United States
(12) Patent Application Publication
(10) Pub. No.: US 2018/0041668 A1
(43) Pub. Date: Feb. 8, 2018

(54) DIGITAL CAMERA FOCUS ASSEMBLY

(71) Applicant: Microsoft Technology Licensing, LLC, Redmond, WA (US)

(72) Inventor: Chengwu Cui, Redmond, WA (US)

(21) Appl. No.: 15/230,219

(22) Filed: Aug. 5, 2016

(51) Int. Cl. H04N 5/225; H04N 5/232

(52) U.S. Cl. CPC H04N 5/2252; H04N 5/2253; H04N 5/2254; H04N 5/23212

(57) ABSTRACT

In a portable electronic device having a digital camera function, focusing of an image may be accomplished by moving a movable image sensor assembly relative to a lens assembly that is affixed in a housing. An image sensor drive, such as a voice coil motor to move the movable image sensor assembly, may be positioned between the movable image sensor assembly and the lens assembly concentric with the lens assembly.

### BACKGROUND

In addition to digital cameras, digital camera function has become widely available as a built-in function for many portable electronic devices such as cellular phones, tablet computers, and laptop computers. Typically, the camera lens assembly, is located on the back side, on the front side, or both the front and back of the portable electronic device. As these portable electronic devices become thinner and more complex with additional features, providing a sufficient range of the lens assembly movement for focusing becomes more difficult to achieve. Due to the thickness of the portable electronic device, a typical single lens assembly does not allow for more complex lens arrangement, and the drive mechanism must be able to provide sufficient force to balance the weight of the lens assembly and to achieve fast and accurate focus adjustments.

### BRIEF SUMMARY

This Summary is provided in order to introduce simplified concepts of the present disclosure, which are further described below in the Detailed Description. This summary is not intended to identify essential features of the claimed subject matter, nor is it intended for use in determining the scope of the claimed subject matter.

In some examples, a focus assembly of a digital camera function adjusts focus of an image to be captured by moving an image sensor relative to a fixed lens assembly. To move the image sensor, an image sensor drive, such as a voice coil motor (VCM), may be activated by an input voltage supplied by a digital-to-analog converter (DAC). In some instances, the image sensor may be lighter weight and/or smaller than the lens assembly, such that a smaller VCM and lower input voltage can be used than is needed for conventional focus assemblies in which the lens assembly is moved relative to a fixed image sensor.

In some examples, the lens assembly may be affixed to a housing of the focus assembly and light entering through the lens assembly may be reflected at an angle to be received in an area away from the area immediately behind the lens assembly. In that case, multiple lens assemblies can be used and the light may be reflected more than once to reach a desired location where the image sensor is positioned. The light may be optically treated or processed, such as filtering and zooming, with an optical device placed between the lens assemblies before reaching the movable image sensor. This arrangement may allow for greater movement of the image sensor relative to at least a portion of the lens assembly.

In some examples, to further reduce the thickness of the focus assembly, the image sensor drive may be positioned between the lens assembly and the movable image sensor. For instance, the image sensor drive may be positioned concentric with at least a portion of the lens assembly. In some examples, this may reduce the overall thickness of a portable electronic device in which the focus assembly is installed.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1A is a schematic diagram of an example digital camera focus assembly with an image sensor positioned immediately behind and movable relative to a lens assembly.

FIG. 1B is a schematic diagram of a portion of an example image sensor assembly showing an image sensor attached to a carrier that is a part of a flexible printed circuit board.

FIG. 2 is a schematic diagram of an example digital camera focus assembly with an image sensor movable relative to a lens assembly.

FIG. 3 is a schematic diagram of an example digital camera focus assembly with two lens assemblies with an image sensor positioned immediately behind and movable relative to one of the lens assemblies.

FIG. 4 is a schematic diagram of an example digital camera focus assembly with two lens assemblies and two reflectors with an image sensor positioned immediately behind and movable relative to one of the lens assemblies.

FIG. 5 is a block diagram of an example portable electronic device including a digital camera focus assembly.

FIG. 6 is a block diagram of an example system usable to perform methods in accordance with at least one aspect of the present disclosure.

FIG. 7 is a flow chart of an example process of focusing in a digital camera focus assembly.

FIG. 8 is a flowchart including example details of one of blocks of FIG. 7.

### DETAILED DESCRIPTION

A common focusing mechanism in portable electronic devices generally involves moving the lens assembly relative to a stationary image sensor by using a drive mechanism such as a voice coil motor (VCM). However, in some instances, the range of movement of the lens assembly may be limited by the thickness of the portable electronic device. Also, the lens assembly is typically relatively heavy, requiring a relatively large VCM and relatively high voltage applied to the VCM to adequately move the lens assembly. This disclosure describes devices and systems that can, in some examples, overcome the difficulties associated with countering the weight of the lens assemblies and providing a sufficient range of lens assembly movement for focusing as these portable electronic devices become thinner and more complex with additional features.

In some examples, a digital camera focus assembly has an image sensor assembly in a housing configured to move, by force generated by an image sensor drive such as a voice coil motor (VCM), for focusing. In some examples, light entering through one or more lens assemblies may be reflected towards the image sensor by one or more reflectors. In some examples, the lens assemblies and/or reflectors may be affixed to the housing such that the lens assemblies, the reflectors, or both are stationary relative to the housing. In such examples, the image sensor is movable relative to one or more of the lens assemblies. The image sensor drive may, in some examples, be positioned between the image sensor and one of the reflectors to reduce the thickness required to house the digital camera focus assembly.

The systems and devices described herein may be implemented in a number of ways. Example implementations are provided below with reference to the following figures.

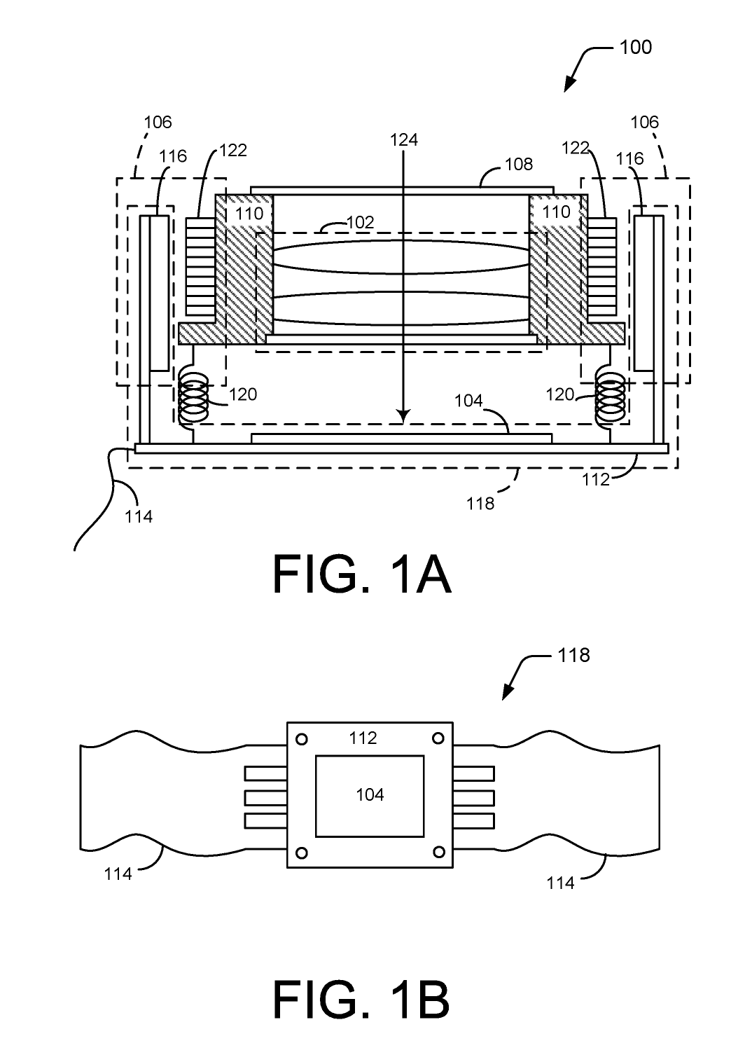

FIG. 1A is a schematic diagram of an example digital camera focusing assembly 100 with an image sensor immediately behind and movable relative a lens assembly. The digital camera focusing assembly 100 may be integrated into a portable electronic device, and may comprise a lens assembly 102, an image sensor 104, and an image sensor drive 106. The lens assembly 102 may comprise multiple lenses and a lens cover 108. The lens assembly 102 may be affixed on the housing 110 and be stationary, and may not require any active support. The image sensor 104 may be mounted on a carrier 112 and connected to a flexible printed circuit board (FPCB) 114. The carrier 112 may also be configured to support a movable part 116, such as a permanent magnet, of an image sensor drive 106, which may be or include a voice coil motor (VCM) positioned parallel to, and/or concentric with, the lens assembly 102. The image sensor 104, the carrier 112, and the movable part 116 of the image sensor drive 106 as a whole may be referred as a movable image sensor assembly 118. FIG. 1B illustrates a schematic diagram of a portion of an example movable image sensor assembly 118 showing the image sensor 104 attached to the carrier 112, which is a part of the FPCB 114.

Referring back to FIG. 1A, the carrier 112 may be coupled to a suspension mechanism 120, shown here as springs, configured to suspend the movable image sensor assembly 118 in a neutral position when the image sensor drive 106 is inactive and no force from the image sensor drive 106 is applied to the movable image sensor assembly 118. A stationary part 122, shown as a coil, of the image sensor drive 106 may be affixed to the housing 110.

As light 124 enters through the lens assembly 102, it is incident upon the image sensor 104, and may be focused by moving the movable image sensor assembly 118 by the image sensor drive 106. The image sensor drive 106 may be positioned between the lens assembly 102 and the image sensor 104. The image sensor drive 106 may be a VCM configured to move the movable image sensor assembly 118 based on an input voltage, and may be concentrically positioned with the lens assembly 102. The input voltage may be varied until a desired focus is achieved, which may be determined, for example, visually by displaying an image to a user or by an autofocus algorithm stored in the portable electronic device.

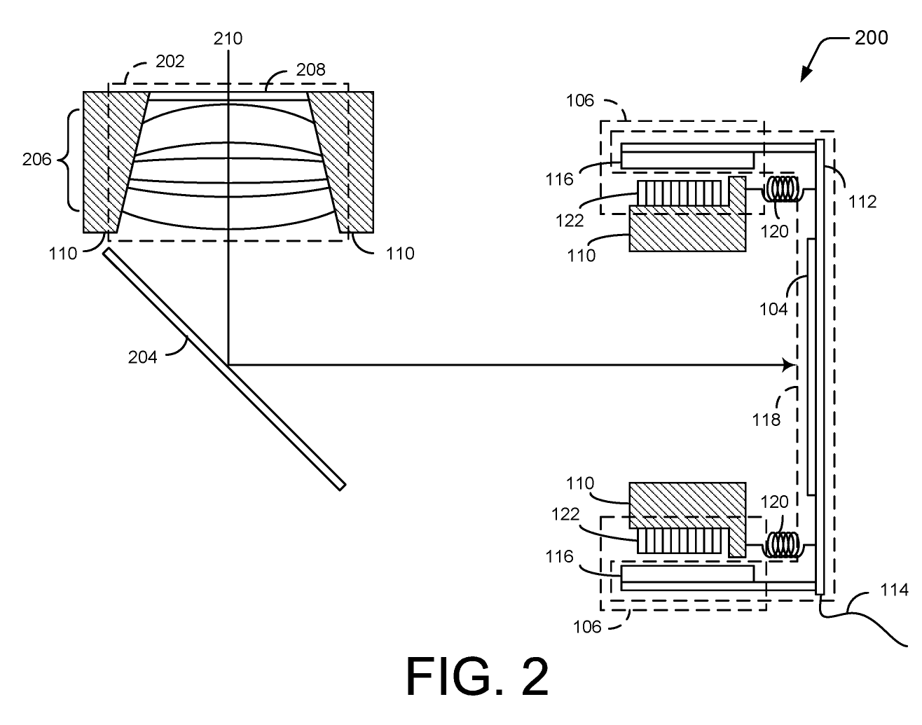

FIG. 2 is a schematic diagram of an example digital camera focusing assembly 200 with the movable image sensor assembly 118 movable relative to a lens assembly 202. The digital camera focusing assembly 200 may be integrated into a portable electronic device, and may comprise the lens assembly 202, a reflector 204, an image sensor 104, and an image sensor drive 106. The lens assembly 202 may comprise multiple lenses 206 and a lens cover 208 (e.g., cover glass or other optically clear or transparent protective material). The lens assembly 202 may be affixed on the housing 110 and be stationary, and may in at least some examples be free of active support. That is, unlike a movable lens assembly, commonly found in a digital camera used in a portable electronic device, the lens assembly 202 does not require any external support, because it is fully supported in a stationary position by the housing.

As discussed with reference to the digital camera focusing assembly 100 of FIG. 1A, the movable image sensor assembly 118 comprises the image sensor 104, the carrier 112, and the movable part 116 of the image sensor drive 106, and may be connected to the flexible printed circuit board 114. The carrier 112 may also be configured to support the movable part 116, such as a permanent magnet, of an image sensor drive 106 which may in some examples be or include a voice coil motor (VCM). In other examples, the image sensor drive 106 may be a motor driven gear, a motor driven threaded sleeve, or other means to move the image sensor assembly 118 relative to the lens assembly 202. The image sensor 114, the carrier 112, and the movable part 116 as a whole may be referred as a movable image sensor assembly 118. The carrier 112 may be coupled to the suspension mechanism 120, shown here as coil springs, configured to suspend the movable image sensor assembly 118 in a neutral position when the image sensor drive 106 is inactive. In other examples, the suspension mechanism 120 may be or include leaf springs, cantilever springs, membranes, diaphragms, bands, straps, or other elements configured to suspend the image sensor assembly 118 relative to the housing 110, while allowing axial movement of the image sensor assembly 118 relative to the light reaching the image sensor 104. The stationary part 122, shown as a coil, of the image sensor drive 106 may be affixed to the housing 110.

As light 210 enters through the lens assembly 202, the reflector 204 reflects the light at an angle to redirect the light away from the area immediately behind the lens assembly 202 and towards the image sensor 104. In this example, the lens assembly 202 is shown to be perpendicular relative to the image sensor 104. The light incident upon the image sensor 104 may be focused by moving the movable image sensor assembly 118 by the image sensor drive 106, which may be positioned between the reflector 204 and the image sensor 104. The image sensor drive 106 may be a VCM configured to move the movable image sensor assembly 118 based on an input voltage. The input voltage may be varied until a desired focus is achieved, which may be determined visually by displaying an image to a user or by an autofocus algorithm stored in the portable electronic device.

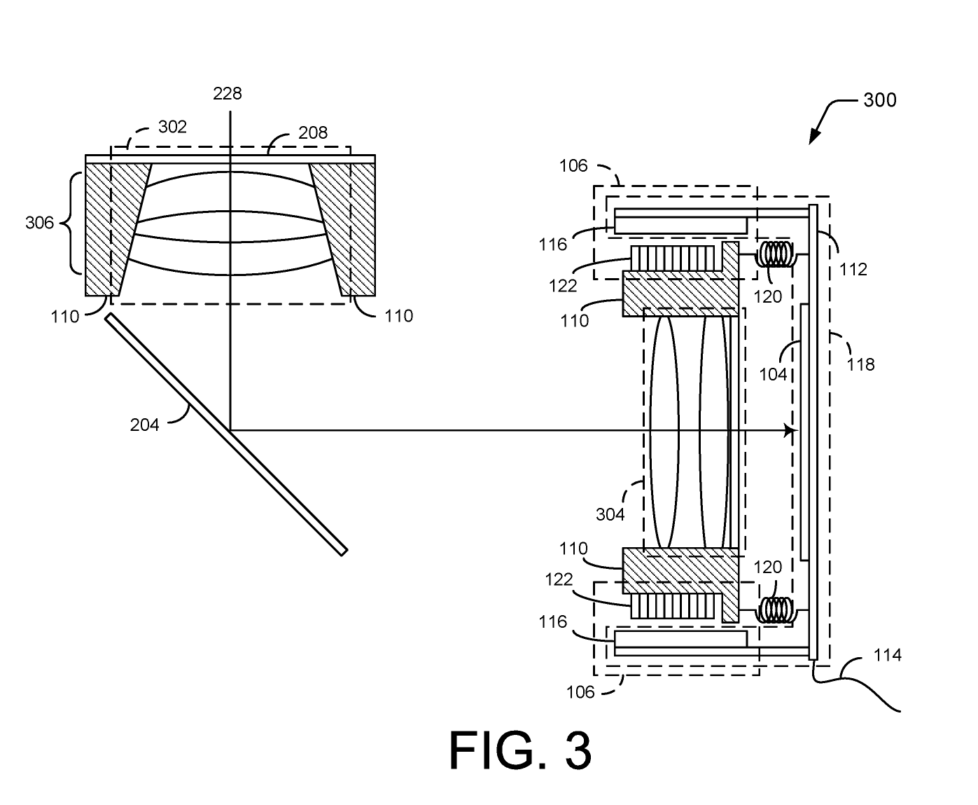

FIG. 3 is a schematic diagram of an example digital camera focus assembly 300 with two lens assemblies, a lens assembly 302 and a sensor lens assembly 304, with the movable image sensor assembly 118 positioned immediately behind and movable relative the sensor lens assembly 304. The sensor lens assembly 304 may comprise more than one lenses and be placed between the reflector 204 and the image sensor 104. Because the sensor lens assembly 304 may be configured to provide an additional optical treatment to the light, the first lens assembly 302 may be made thinner, comprising lenses 306 that are less complex, compared to the digital camera focus assembly 200 with the single lens assembly 202.

As light 228 enters through the lens assembly 302, and the reflector 204 reflects the light at an angle to redirect the light away from the area immediately behind the lens assembly 302 and towards the image sensor 104. Before reaching the image sensor 104, the light may go through another set of lenses of the sensor lens assembly 304 for additional optical treatment. The light incident upon the image sensor 104 may be focused by moving the movable image sensor assembly 118 by the image sensor drive 106, which may be positioned between the reflector 204 and the image sensor 104. The image sensor drive 106 may be a VCM configured to move the movable image sensor assembly 118 based on an input voltage, and may be concentrically positioned with the lens assembly 304. The input voltage may be varied until a desired focus is achieved, which may be determined visually by displaying an image to a user or by an autofocus algorithm stored in the portable electronic device.

Although the lens assemblies 302 and 304 are described above as stationary, in some examples, a portion of the lens assembly, for example, one lens or one of the assemblies, may be movable relative to the image sensor 104 while other portions of the lens assembly are fixed and are not movable relative to the image sensor 104.

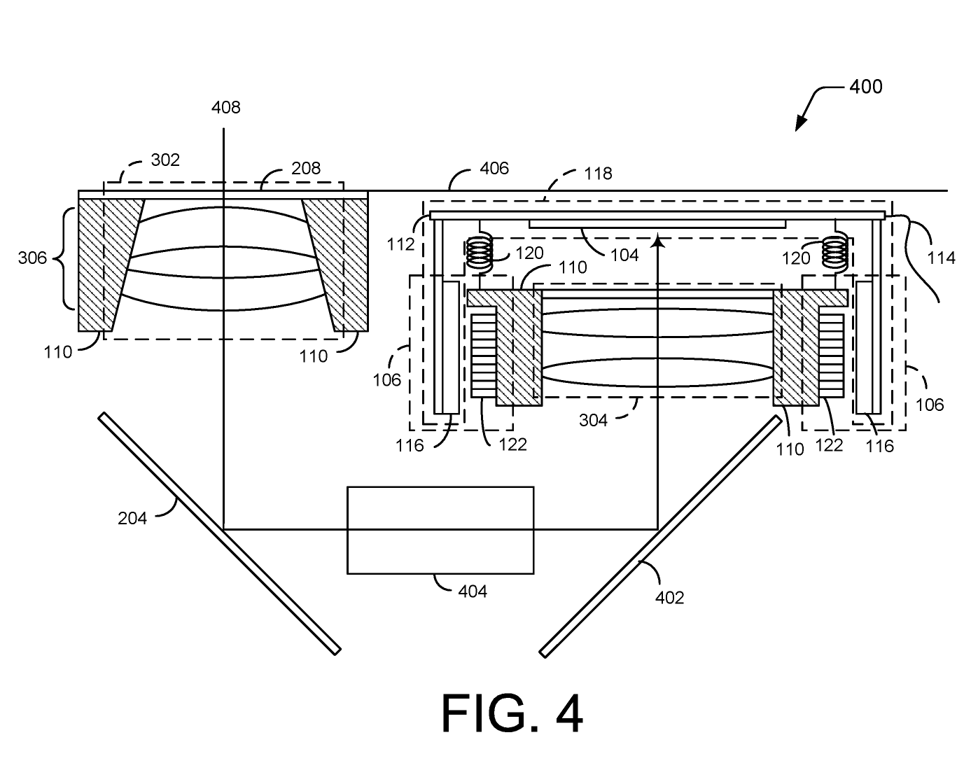

FIG. 4 is a schematic diagram of an example digital camera focus assembly 400 with two lens assemblies, the lens assembly 302 and the sensor lens assembly 304, and two reflectors, the reflector 204 and a sensor reflector 402, with the movable image sensor assembly 118 positioned immediately behind and movable relative to the sensor lens assembly 304. The sensor reflector 402 may be positioned between the reflector 204 and sensor lens assembly 304, and configured to reflect the light once more to redirect the light towards the image sensor 104 through the sensor lens assembly 304. In this example, the lens assembly 302 and the sensor lens assembly 304 are shown to be oriented parallel to each other. An optical device 404, configured to provide optical treatment to the light such as filtering and/or zooming (magnifying or reducing) of the image, may be placed between the reflector 204 and the sensor reflector 402. In some examples, the optical device 404 may comprise one or more colored lenses for filtering, an adjustable set of lenses for zooming, an adjustable aperture control, and the like. A housing boundary 406 represents a physical boundary of the movement of the image sensor 104.

Light 408 enters through the lens assembly 302, and the reflector 204 reflects and redirects the light towards the sensor reflector 402. The optical device 404, located between the reflector 204 and the sensor reflector 402, may provide some optical treatments, such as filtering and/or zooming, to the light as it passes through before reaching the sensor reflector 402. The sensor reflector 402 reflects the light towards the image sensor 104 through the sensor lens assembly 304 which may provide additional optical treatments. Focusing of the light, or at least a portion of an image associated with the light, onto the image sensor 104 may be accomplished by moving the movable image sensor assembly 118 by the image sensor drive 106 positioned between the sensor reflector 402 and the image sensor 206. The image sensor drive 106 may be a VCM configured to move the movable image sensor assembly 118 based on an input voltage, and may be concentrically positioned with the lens assembly 304. The input voltage may be varied until a desired focus is achieved, which may be determined visually by displaying an image to a user or by an autofocus algorithm stored in the portable electronic device.

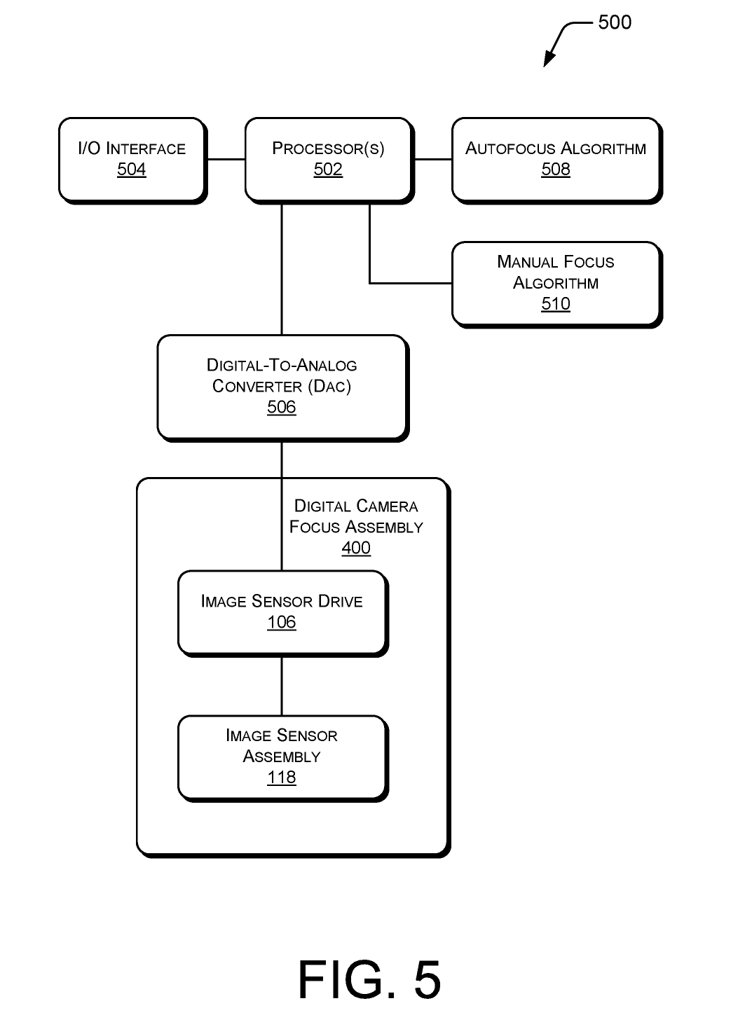

FIG. 5 is a block diagram of an example portable electronic device 500 including a digital camera focus assembly 400. The digital camera focus assembly 400 may be a component of the portable electronic device 500, such as a cellular phone, a tablet computer, a personal computer, and the like. The portable electronic device 500 may comprise, in addition to the digital camera focus assembly 400, one or more processors 502, which may directly or indirectly communicate with other assemblies and components of the portable electronic device 500, an input/output (I/O) interface 504, which may be a touch screen, coupled to the processors 502 and may receive an input requesting to activate a camera function, and a digital-to-analog converter (DAC) 506. The I/O interface 504 may include a physical and/or graphical user interface including a keyboard, mouse, pen, microphone or other voice input device, touch pad, display screen (e.g., touch screen or otherwise), and/or speakers. For instance, in some examples, a display screen may display a graphical user interface including an image of the light received by the image sensor 104. In some examples, the graphical user interface may additionally or alternatively include an autofocus control usable to perform an autofocus calibration or adjust other settings. Once the camera function is activated, the digital camera focus assembly 400 may run an autofocus algorithm 508 and automatically focus on a default area of an image to a predetermined level. Alternatively, the I/O interface 504 may receive an input that specifies an area the image to focus or that focusing is to be manually performed, invoking a manual focus algorithm 510, by a user who may specify an area of the image to be focused and how well it should be focused. The processors 502 provides the DAC 506 with a digital input value, a 16-bit word for example, corresponding to a focusing requirement, which may be generated from the autofocus algorithm 508 or the manual focus algorithm 510 described above. The DAC 506 converts the digital input value to a corresponding analog voltage and applies it to the image sensor drive 106, which results in a movement of the movable image sensor assembly 118 to a position corresponding to the voltage applied to the image sensor drive 106.

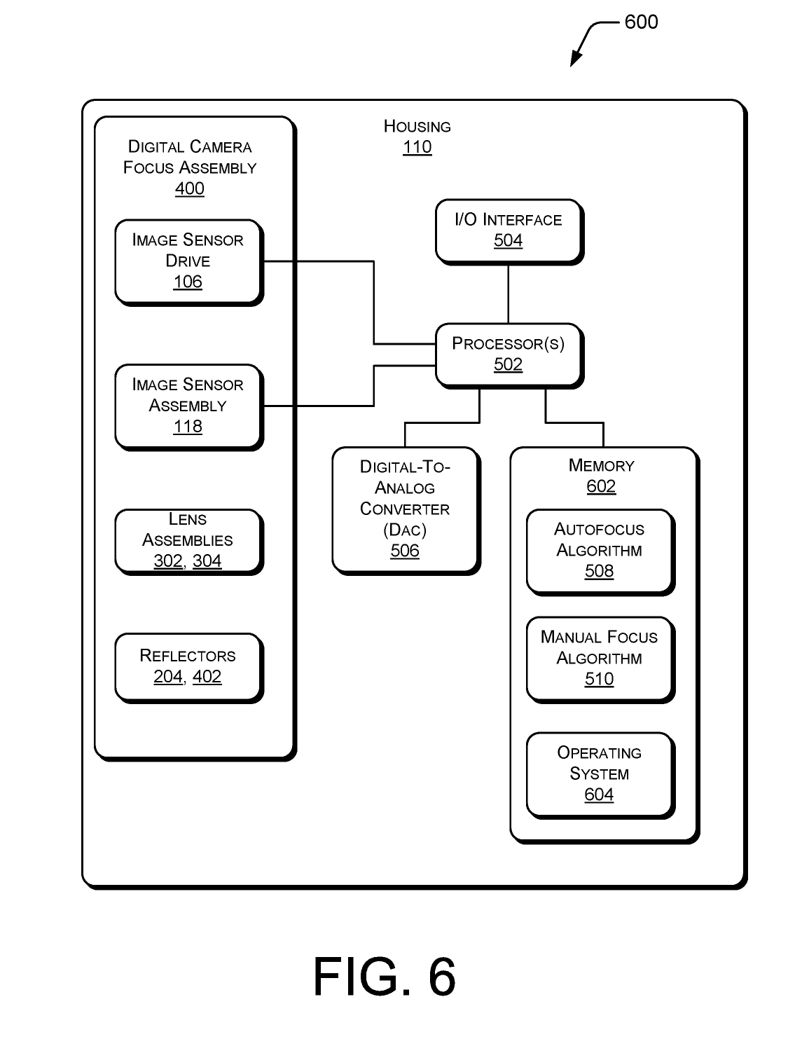

FIG. 6 is a block diagram of an example digital camera focus system 600 usable to perform tasks described above. The system may be embodied as or included in, for example, a personal computer (PC), laptop computer, tablet computer, cellular phone, or any other computing device equipped with digital camera functionality. The system 600 comprises the housing 110, one or more processors 502, the I/O interface 504, a digital-to-analog converter (DAC) 506, a digital camera focus assembly 400, and memory 602. The I/O interface 504, the digital camera focus assembly 400, the DAC 506, and memory 602 are communicatively coupled to the processor(s) 502. As described above, the digital camera focus assembly 400 comprises the lens assemblies 302 and 304, the reflectors 204 and 402, the movable image sensor assembly 118, and image sensor drive 106. The system 600 may also include other modules and devices normally associated with portable electronic devices such as physical or graphical interfaces (e.g., displays, touch screens, buttons, switches, knobs, dials, indicator lights, menus, etc.), sensors, speakers, batteries, and the like.

The memory 602 may store program instructions that are loadable on and executable by the processor(s) 502, as well as data generated during execution of, and/or usable in conjunction with, these programs. In the illustrated example, memory 502 stores an operating system 604, which provides basic system functionality of the system 600 and, among other things, provides for operation of the other programs and modules of the system 600.

The memory 602 may include various aspects of digital camera focusing such as the autofocus algorithm 508, the manual focus algorithm 510 as described above. Some of these aspects may be implemented as software modules, or as hardware components. The processors 502 provides the DAC 506 with a digital input value, a 16-bit word for example, corresponding to a focusing requirement, which may be generated from the autofocus algorithm 508 or the manual focus algorithm 510 described above. The DAC 506 converts the digital input value to a corresponding analog voltage and applies it to the image sensor drive 106, which results in a movement of the movable image sensor assembly 118 to a position corresponding to the voltage applied to the image sensor drive 106.

Depending on the configuration and type of electronic device used, memory 602 of the system 600 in FIG. 6 may include volatile memory (such as random access memory (RAM)) and/or non-volatile memory (such as read-only memory (ROM), flash memory, etc.). Memory 602 may also include additional removable storage and/or non-removable storage including, but not limited to, flash memory, magnetic storage, optical storage, and/or tape storage that may provide non-volatile storage of computer-readable instructions, data structures, program modules, and other data for computing system 600.

Memory 602 is an example of computer-readable media. Computer-readable media includes at least two types of computer-readable media, namely computer storage media and communications media. Computer storage media includes volatile and non-volatile, removable and non-removable media implemented in any process or technology for storage of information such as computer-readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer storage media does not include communication media.

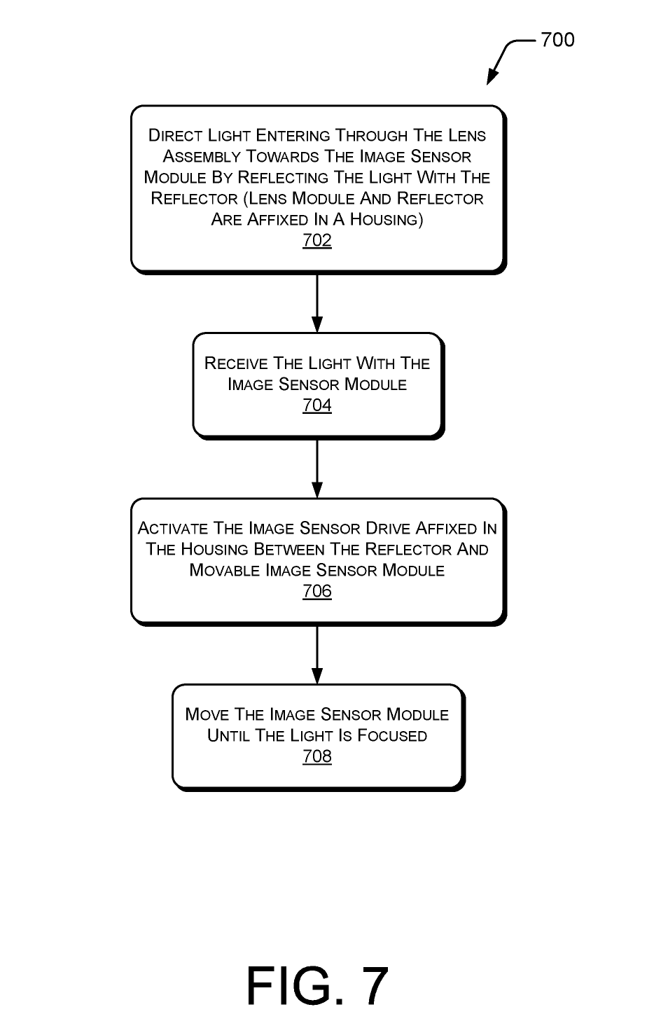

FIG. 7 is a flow chart of an example process 700 of focusing in a digital camera focus assembly. In some examples, the process 700 may be performed using one of the camera focus assemblies 100, 200, 300, or 400, and/or the portable electronic device 500. However, in other examples, the process 700 may be performed using other systems and devices. Likewise, the camera focus assemblies 100, 200, 300, or 400, and the portable electronic device 500 may be used to perform other processes.

By way of example and not limitation, the process 700 is described with reference to the digital camera focus assembly 400 of FIG. 4, which includes two lens assemblies 302 and 304, and two reflectors 204 and 402, with the image sensor 104 positioned immediately behind and movable relative to the sensor lens assembly 304. At block 702, light entering through the lens assembly 302 is directed towards the movable image sensor module 118 by reflecting the light with the reflector 204. The lens assembly 302 and the reflector 204 are stationary and affixed to the housing 110. As described above with reference to the sensor lens assembly 304 and the sensor reflector 402, the light 408 may be reflected more than once and may go through another set of lenses, such as the sensor lens assembly 304, before being received by the image sensor 104. The light 408 may go through the optical device 404, as described above, for an optical treatment such as filtering, zooming, and aperture adjustment before being received by the image sensor 104.

At block 704, the light 408 is received by the image sensor 104 of the movable image sensor assembly 118. At block 706, the image sensor drive 106, which in this example is fixed to the housing 110 and is located between the sensor reflector 402 and the image sensor 104, is activated. At block 708, the image sensor drive 106 moves the movable image sensor assembly 118 until the light is focused. The image sensor drive 106 may be a voice coil motor (VCM) and may move the movable image sensor assembly 118 based on an analog input voltage received from a digital-to-analog converter (DAC). The analog input voltage may be varied until a desired focus is achieved, which may be determined visually by displaying an image to a user or by an autofocus algorithm 508.

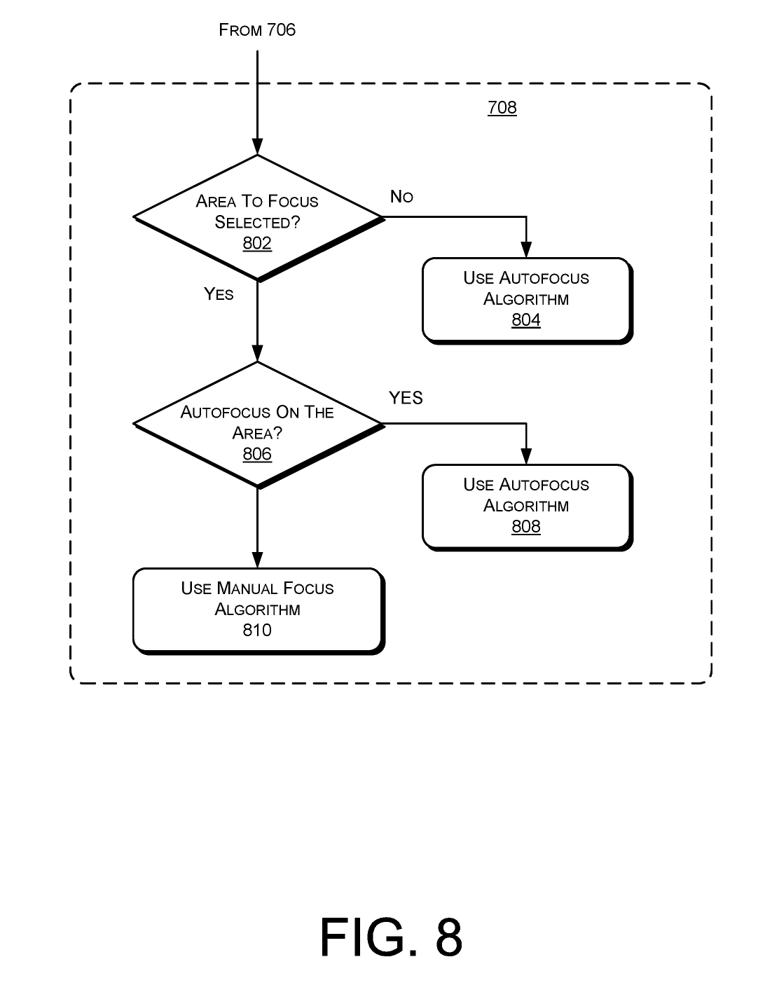

FIG. 8 is a flow chart including example details of block 708 of FIG. 7. The I/O interface 504 may display an image associated with the light received by the image sensor 104, and at block 802, the process may determine if a user input indicative of an area of the image to be focused is received. For example, if no user input is received, then the process may default to execute the autofocus algorithm 508 with a predetermined area to be focused at block 804. If the user input is received, whether to use the autofocus algorithm 508 for the indicated area may be determined at block 806. If it is determined to use the autofocus algorithm 508 for the indicated area, then the process executes the autofocus algorithm 508 with the indicated area to be focused at block 808. Otherwise, the process executes a manual focus algorithm 510 at block 810, and allows the user to achieve a desired level of focus of the indicated area based on another input received by the I/O interface 504.

### Example Clauses

A. A digital camera focus assembly comprising: a housing; a lens assembly disposed in and affixed to the housing to receive light; a movable image sensor assembly disposed in the housing and configured to receive the light from the lens assembly and to generate an image associated with the light, the movable image sensor assembly being movable along a path of the light relative to the lens assembly; and an image sensor drive disposed in the housing and coupled to the image sensor, the image sensor drive positioned in parallel with at least a portion of the lens assembly between the lens assembly and the movable image sensor assembly, the image sensor drive configured to move the movable image sensor assembly relative to the lens assembly to adjust a focus of the light resolved at the image sensor.

B. A digital camera focus assembly as paragraph A recites, further comprising a flexible printed circuit board coupling the movable image sensor assembly to one or more processors and/or memory.

C. A digital camera focus assembly as paragraph B recites, wherein the image sensor drive comprises a voice coil motor disposed concentric with at least a portion of the lens assembly.

D. A digital camera focus assembly as paragraph C recites, further comprising: a suspension mechanism attached to the housing and the flexible printed circuit board, the suspension mechanism suspending the movable image sensor assembly in a neutral position when the image sensor drive is inactive.

E. A digital camera focus assembly as any of paragraphs A-D recite, further comprising: a reflector disposed in and affixed to the housing, the reflector configured to reflect the light entering through the lens assembly at an angle towards the image sensor.

F. A digital camera focus assembly as paragraph E recites, further comprising: a sensor lens assembly disposed in and affixed to the housing between the reflector and the image sensor, the sensor lens assembly configured to pass the light towards the image sensor.

G. A digital camera focus assembly as paragraph E recites, further comprising: a sensor reflector disposed in the housing and positioned in a path of the light between the reflector and the image sensor, the sensor reflector configured to reflect the light at another angle towards the image sensor.

H. A digital camera focus assembly as paragraph G recites, further comprising: a sensor lens assembly disposed in and affixed to the housing in a path of the light between the sensor reflector and the image sensor, the sensor lens assembly configured to pass the light towards the image sensor.

I. A digital camera focus assembly as paragraph H recites, further comprising: an optical device disposed in the housing and positioned in a path of the light between the reflector and the sensor reflector, the optical device configured to provide an optical effect upon the light passing through, wherein the optical effect upon the light passing through is at least one of: filtering to reduce a predetermined light spectrum, or magnifying or reducing a size of the image.

J. A portable electronic device comprising: a housing; one or more processors disposed in the housing; a digital camera focus assembly coupled to the one or more processors, comprising: a lens assembly disposed in the housing to receive light; a movable image sensor assembly disposed in the housing and configured to receive the light from the lens assembly and to generate an image associated with the light, the movable image sensor assembly being movable along a path of the light relative to the lens assembly; and an image sensor drive disposed in the housing and coupled to the image sensor, the image sensor drive positioned in parallel with at least a portion of the lens assembly between the lens assembly and the movable image sensor assembly, the image sensor drive configured to move the movable image sensor assembly relative to the lens assembly to adjust a focus of the light resolved at the image sensor.

K. A portable electronic device as paragraph J recites, wherein the digital camera focus assembly further comprises a flexible printed circuit board coupling the movable image sensor assembly to the one or more processors and/or memory.

L. A portable electronic device as paragraph K recites, wherein the image sensor drive comprises a voice coil motor disposed concentric with at least a portion of the lens assembly.

M. A portable electronic device of as paragraph L recites, wherein the digital camera focus assembly further comprises a suspension mechanism attached to the housing and to the flexible printed circuit board, the suspension mechanism configured to suspend the movable image sensor assembly in a neutral position when the image sensor drive is inactive.

N. A portable electronic device as paragraph L recites, wherein the digital camera focus assembly further comprises a sensor reflector disposed in the housing and positioned in a path of the light between the reflector and the image sensor, the sensor reflector configured to reflect the light at another angle towards the image sensor.

O. A portable electronic device as paragraph N recites, wherein the digital camera focus assembly further comprises a sensor lens assembly disposed in and affixed to the housing in a path of the light between the sensor reflector and the image sensor, the sensor lens assembly configured to pass the light towards the image sensor.

P. A portable electronic device as any of paragraphs J-O recite, wherein the digital camera focus assembly further comprises a reflector disposed in and affixed to the housing, the reflector configured to reflect the light entering through the lens assembly at an angle towards the image sensor.

Q. A portable electronic device as paragraph P recites, wherein the digital camera focus assembly further comprises a sensor lens assembly disposed in and affixed to the housing between the reflector and the image sensor, the sensor lens assembly configured to pass the light towards the image sensor.

R. A portable electronic device as paragraph Q recites, wherein the digital camera focus assembly further comprises an optical device positioned between the reflector and the sensor reflector, the optical assembly configured to provide an optical effect upon the light passing through, wherein the optical effect upon the light passing through is at least one of: filtering to reduce a predetermined light spectrum, or magnifying or reducing a size of the image.

S. A system comprising: a housing; one or more processors; a digital camera focus assembly coupled to the one or more processors, the digital camera focus assembly comprising; a lens assembly disposed in and affixed to the housing to receive light; a movable image sensor assembly disposed in the housing and configured to receive light from the lens assembly and to generate an image associated with the light, the movable image sensor assembly being movable along a path of the light, and an image sensor drive disposed in housing and coupled to the image sensor, the image sensor drive positioned between the lens assembly and the movable image sensor assembly; an input/output (I/O) interface coupled to the one or more processors; and memory storing instructions that, when executed by the one or more processors, cause the system to: receive an input from the I/O interface to activate a camera function; and move the movable image sensor assembly to adjust a focus of the light at the image sensor.

T. A system as paragraph S recites, wherein the instructions, when executed by the one or more processors, further cause the system to: provide an input value from the one or more processors to a digital-to-analog converter (DAC); generate, by the DAC, an input voltage corresponding to the input value; and apply the input voltage to the image sensor drive to move the movable image sensor assembly.

Although the disclosure uses language that is specific to structural features and/or methodological acts, the disclosure is not limited to the specific features or acts described. Rather, the specific features and acts are disclosed as illustrative forms of implementing the disclosure.

What is claimed is:

1. A digital camera focus assembly comprising:
a housing;
a lens assembly disposed in and affixed to the housing to receive light;
a movable image sensor assembly disposed in the housing and configured to receive the light from the lens assembly and to generate an image associated with the light, the movable image sensor assembly being movable along a path of the light relative to the lens assembly; and
an image sensor drive disposed in the housing and coupled to the image sensor, the image sensor drive positioned in parallel with at least a portion of the lens assembly between the lens assembly and the movable image sensor assembly, the image sensor drive configured to move the movable image sensor assembly relative to the lens assembly to adjust a focus of the light resolved at the image sensor.

2. A digital camera focus assembly of claim 1, further comprising a flexible printed circuit board coupling the movable image sensor assembly to one or more processors and/or memory.

3. A digital camera focus assembly of claim 2, wherein the image sensor drive comprises a voice coil motor disposed concentric with at least a portion of the lens assembly.

4. A digital camera focus assembly of claim 3, further comprising:
a suspension mechanism attached to the housing and the flexible printed circuit board, the suspension mechanism suspending the movable image sensor assembly in a neutral position when the image sensor drive is inactive.

5. A digital camera focus assembly of claim 1, further comprising:
a reflector disposed in and affixed to the housing, the reflector configured to reflect the light entering through the lens assembly at an angle towards the image sensor.

6. A digital camera focus assembly of claim 5, further comprising:
a sensor lens assembly disposed in and affixed to the housing between the reflector and the image sensor, the sensor lens assembly configured to pass the light towards the image sensor.

7. A digital camera focus assembly of claim 5, further comprising:
a sensor reflector disposed in the housing and positioned in a path of the light between the reflector and the image sensor, the sensor reflector configured to reflect the light at another angle towards the image sensor.

8. A digital camera focus assembly of claim 7, further comprising:
a sensor lens assembly disposed in and affixed to the housing in a path of the light between the sensor reflector and the image sensor, the sensor lens assembly configured to pass the light towards the image sensor.

9. A digital camera focus assembly of claim 8, further comprising:
an optical device disposed in the housing and positioned in a path of the light between the reflector and the sensor reflector, the optical device configured to provide an optical effect upon the light passing through, wherein the optical effect upon the light passing through is at least one of:
filtering to reduce a predetermined light spectrum, or
magnifying or reducing a size of the image.

10. A portable electronic device comprising:
a housing;
one or more processors disposed in the housing;
a digital camera focus assembly coupled to the one or more processors, comprising:
a lens assembly disposed in the housing to receive light;
a movable image sensor assembly disposed in the housing and configured to receive the light from the lens assembly and to generate an image associated with the light, the movable image sensor assembly being movable along a path of the light relative to the lens assembly; and
an image sensor drive disposed in the housing and coupled to the image sensor, the image sensor drive positioned in parallel with at least a portion of the lens assembly between the lens assembly and the movable image sensor assembly, the image sensor drive configured to move the movable image sensor assembly relative to the lens assembly to adjust a focus of the light resolved at the image sensor.

11. A portable electronic device of claim 10, wherein the digital camera focus assembly further comprises a flexible printed circuit board coupling the movable image sensor assembly to the one or more processors and/or memory.

12. A portable electronic device of claim 11, wherein the image sensor drive comprises a voice coil motor disposed concentric with at least a portion of the lens assembly.

13. A portable electronic device of claim 12, wherein the digital camera focus assembly further comprises a suspension mechanism attached to the housing and to the flexible printed circuit board, the suspension mechanism configured to suspend the movable image sensor assembly in a neutral position when the image sensor drive is inactive.

14. A portable electronic device of claim 12, wherein the digital camera focus assembly further comprises a sensor reflector disposed in the housing and positioned in a path of the light between the reflector and the image sensor, the sensor reflector configured to reflect the light at another angle towards the image sensor.

15. A portable electronic device of claim 14, wherein the digital camera focus assembly further comprises a sensor lens assembly disposed in and affixed to the housing in a path of the light between the sensor reflector and the image sensor, the sensor lens assembly configured to pass the light towards the image sensor.

16. A portable electronic device of claim 10, wherein the digital camera focus assembly further comprises a reflector disposed in and affixed to the housing, the reflector configured to reflect the light entering through the lens assembly at an angle towards the image sensor.

17. A portable electronic device of claim 16, wherein the digital camera focus assembly further comprises a sensor lens assembly disposed in and affixed to the housing between the reflector and the image sensor, the sensor lens assembly configured to pass the light towards the image sensor.

18. A portable electronic device of claim 17, wherein the digital camera focus assembly further comprises an optical device positioned between the reflector and the sensor reflector, the optical assembly configured to provide an optical effect upon the light passing through, wherein the optical effect upon the light passing through is at least one of:
filtering to reduce a predetermined light spectrum, or
magnifying or reducing a size of the image.

19. A system comprising:
a housing;
one or more processors;
a digital camera focus assembly coupled to the one or more processors, the digital camera focus assembly comprising;
a lens assembly disposed in and affixed to the housing to receive light;
a movable image sensor assembly disposed in the housing and configured to receive light from the lens assembly and to generate an image associated with the light, the movable image sensor assembly being movable along a path of the light, and
an image sensor drive disposed in housing and coupled to the image sensor, the image sensor drive positioned between the lens assembly and the movable image sensor assembly;
an input/output (I/O) interface coupled to the one or more processors; and
memory storing instructions that, when executed by the one or more processors, cause the system to:
receive an input from the I/O interface to activate a camera function; and
move the movable image sensor assembly to adjust a focus of the light at the image sensor.

20. A system of claim 19, wherein the instructions, when executed by the one or more processors, further cause the system to:
provide an input value from the one or more processors to a digital-to-analog converter (DAC);
generate, by the DAC, an input voltage corresponding to the input value; and
apply the input voltage to the image sensor drive to move the movable image sensor assembly.
